(19) United States
(12) Patent Application Publication
(10) Pub. No.: US 2003/0048433 A1
(43) Pub. Date: Mar. 13, 2003

(54) Cytometer signal processing system and method

(76) Inventor: Jean-Marie Desjonqueres, Caen (FR)

Correspondence Address: DORSEY & WHITNEY LLP, Suite 3400, Four Embarcadero Center, San Francisco, CA, 94111-4187, US

(21) Appl. No.: 10/153,066

(22) Filed: May 20, 2002

Related U.S. Application Data
(60) Provisional application No. 60/295,349, filed on Jun. 1, 2001.

(51) Int. Cl. G01N 21/00

(52) U.S. Cl. 356/73; 356/317

(57) ABSTRACT

A cytometer system is described in which a stream containing sample particles flows past a light beam. The particles either naturally fluoresce or are tagged to fluoresce when they pass through the beam. The particles also scatter the light. Detectors receive the emitted fluorescent light and the scattered light and generate output signals. The output signals are processed by a configured processor to provide a signal value for later analysis of sample. In later analysis, only output signals generated by emitted or scattered light having an amplitude greater than the signal value provide an output signal.

### RELATED APPLICATIONS

This application claims priority to U.S. Provisional Application Serial No. 60/295,349 filed Jun. 1, 2001.

### BRIEF DESCRIPTION OF THE INVENTION

This invention relates generally to a cytometer signal processing system and method, and more particularly to such a system in which the signal threshold is set for peak detection.

### BACKGROUND OF THE INVENTION

The detection and analysis of individual particles or cells in a suspension is important in medical and biological research. It is particularly important to be able to measure characteristics of particles such as concentration, number, viability, identification and size. Individual particles or cells include, for example, bacteria, viruses, DNA fragments, cells, molecules and constituents of whole blood.

Typically, such characteristics of particles are measured using flow cytometers. In flow cytometers, particles which are either intrinsically fluorescent or are tagged or labeled with a fluorescent marker, are caused to flow past a beam of radiant energy which excites the particles or labeled particles to cause emission of fluorescent light. The particles may flow in a so-called sheath flow, or they can flow through a capillary. One or more photodetectors detect the fluorescent light emitted by the particles or labeled particles at selected wavelengths as they move past the beam of radiant energy. The photodetectors generate signals representative of the particles. In most cytometers, a photodetector is also employed to measure light scattered by the particles to generate signals indicative of the passage and size of particles.

A typical output signal from each detector has a base value (a little noisy) with positive peaks corresponding to particles. The base value is stable, but depends on the detector and the electronic offset. The output signals from the photodetectors are in the form of peaks or pulses. The base value may include signals due to light scattered by the sheath or the capillary and other optical components. The base value may also include electronic noise. The base or threshold value is unknown and must be calculated for each detector. If the signal pulses from the particles are too small due to the size of the particles or due to a low level of fluorescence, the passage of particles may be missed if the threshold is set too high. Certain analyses require that the threshold value be set just above the base value in order to detect particles which emit low level levels of light. In other analyses, it may be desirable to set the threshold value such that only large peaks are detected. Thus, it is important to be able to determine the base value whereby the threshold value can be set to detect particles.

### OBJECTS AND SUMMARY OF THE INVENTION

It is an object of the present invention to provide a signal-processing system in which the base value is determined for each detector which permits the setting of a threshold value for detecting signals generated by the passage of particles.

The threshold or base value at which particles are recognized by the signal processing system is set by first causing the sample solution with particles to flow past the radiant energy and detecting scattered and emitted fluorescent light with suitable photo-detectors such as photo-multiplier tubes. The scatter detector provides an analog output signal with a base amplitude and peaks representing all particles. The other detectors provide output signals with base amplitude and peaks representing particles which fluoresce at the wavelength for which the detector and optics are designed. The output signals for each detector are sampled at a predetermined rate, digitized and stored in buffers. An arbitrary threshold is set, and stored signals are processed to detect peaks. The peak values are then subtracted from the stored signals to provide a base value for each of the detectors. An offset is added to the base value to establish the threshold value that is used to conduct an analysis or assay of the sample. The output of each detector is then processed to detect peaks above the threshold value, indicative of a particle which scatters or fluoresces as the case may be. The peak data may include, for each peak, height, width, area, time, etc. The peak data can then be processed according to the particular application, for example, the total number of particles for a particular volume of sample to give concentration, or, with proper labeling, the viability of cells or their apoptosis.

### BRIEF DESCRIPTION OF THE DRAWINGS

The invention will be more clearly understood from the following description when read in conjunction with the accompanying drawings, in which:

FIG. 1 is a schematic diagram of a flow cytometer.

FIG. 2 shows a typical output signal from one of the detectors of FIG. 1.

FIG. 3 is a block diagram of the circuitry employed to digitize the output of a detector.

FIGS. 4A-4C graphically illustrate the steps in setting the threshold value above which an output pulse will be recognized.

FIG. 5 is a flow chart showing setting of the threshold value.

FIG. 6 is a flow chart showing threshold calculation.

FIG. 7 is a flow chart illustrating the processing of the digital signals for peak determination.

FIG. 8 is a flow chart showing data acquisition during an assay.

FIG. 9 shows the typical relationship of the peak values obtained for signals from the plurality of detectors.

### DESCRIPTION OF THE PREFERRED EMBODIMENT

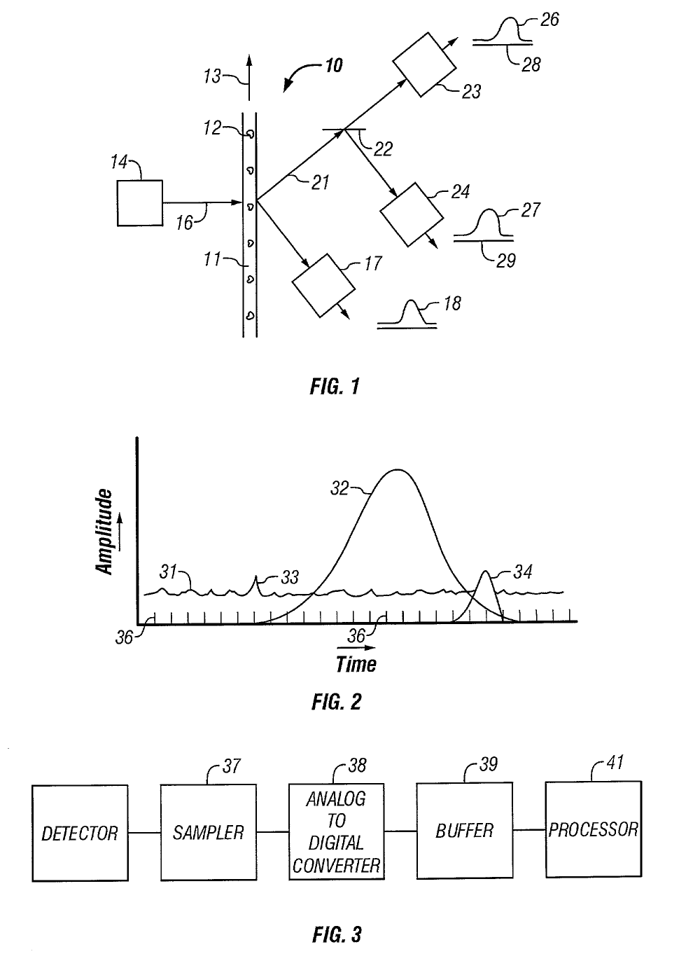

Referring to FIG. 1, there is schematically illustrated a cytometer or particle analyzer 10. As used herein, “particle” means particles or cells, for example bacteria, viruses, DNA fragments, blood cells, molecules and constituents of whole blood. A fluid stream 11 with particles 12 flows in the direction indicated by the arrow 13. The sample or fluid stream may be within a sheath, not shown, or it may be in a capillary, not shown. A light source, such as laser 14, emits a light beam 16 of selected wavelength. The beam strikes particles which flow through the beam. In order to count all particles which pass through the beam, light scattered by the particles is detected by an optical system including a detector 17. The detector provides an output signal such as that shown by the peak 18. The size and shape of the peak is dependent upon the size of the particle. The occurrence of the peak indicates that a particle has traversed the light beam.

If the particles are intrinsically fluorescent, or if the particles have been tagged or labeled with a fluorescent dye, they will emit light 21 at characteristic wavelengths as they pass through the beam 16. The light is detected at an angle with respect to the beam 16 so that no direct light is detected. The fluorescent light is directed to a beam splitter 22 which passes light above a given wavelength and reflects light below the wavelength. Transmitted light is detected by detector 23 while reflected light is detected by the detector 24. The detectors 23 and 24 may, for example, be photomultiplier tubes. For example, the beam splitter reflects light having wavelengths less than 620 nm and transmits light having a greater wavelength. Filters, not shown, may be placed in front of the detectors 23 and 24 to pass light at specific wavelengths, such as 580 nm and 675 nm, which will permit detection of particles tagged with readily available materials. The output of the detectors is shown as pulses or peaks 26 and 27 above base values 28 and 29, respectively. It should be appreciated that the foregoing description of a cytometer is not detailed, and that an actual system will include optical elements to collect and direct the light. However, the foregoing explanation suffices in that it shows how the signals which are to be processed by the inventive signal processing system are obtained. Reference is made to co-pending application Serial No. 09/844,080 filed Apr. 26, 2001 for a more complete description of a suitable cytometer.

The actual output peaks or pulses from the detectors 17, 23 and 24 include a base value which includes optical, electronic and other noise components. The base value is stable, but depends on the detector, the optical path and electronic offset. The noise is a low as possible, but depends on the gain setting of the detector. FIG. 2, which is an enlarged view of one of the peaks, shows that the signal includes a base value 31 and a particle pulse or peak 32. The peak amplitude increases as the particle enters the beam 16 to a maximum, then decreases as the particle leaves the beam. Referring to FIG. 2, the base may include spikes, such as 33, which may arise from contaminating material, etc. and low amplitude particle signals 34. The processing system, to be described, permits the setting of a threshold value which will reject such signals. However, the peak value may be very low and the threshold value may be set to detect peaks that are only slightly above the base value 31.

Digital signal processing of the detector output signals is preferred. To the end the output signals from each of the detectors is digitized. The signal amplitude is sampled at periodic intervals 36 by the sampler 37, FIG. 3. The sampling frequency is selected to provide a good digital representation of the detector output signal. More particularly, the sampling rate is related to the flow rate of the fluid and the size of the particles. The amplitude of the signal for each sample is digitized by analog-to-digital converter 38 and stored in buffer 39. The digital output will be representative of the pulse height, pulse width, and pulse shape. With the output of the detectors time stamped, it is possible to construct a matrix of coincidence of peaks relative to a selected detector. The digital signals are then processed by processor or computer 41 to obtain a signal representative of the base value 31.

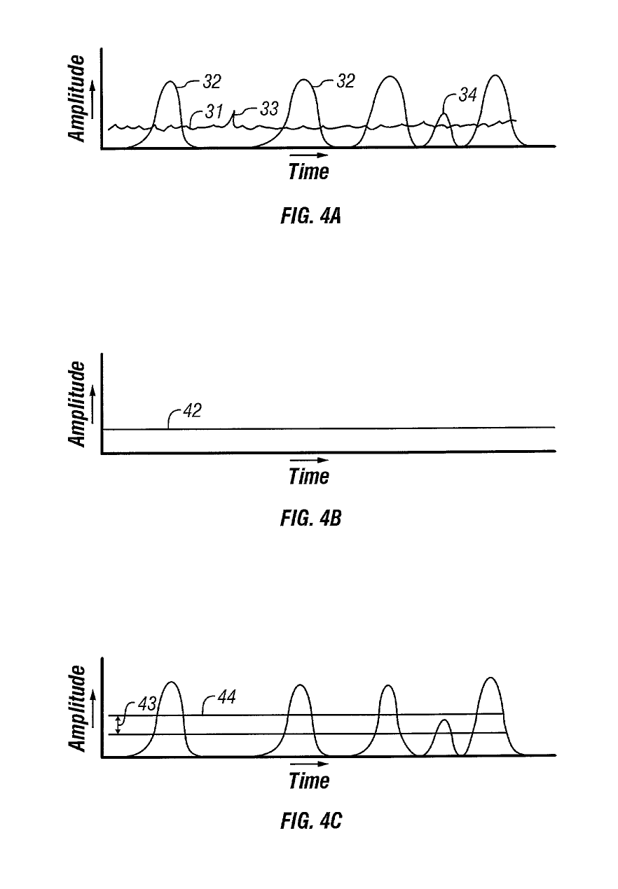

FIG. 4A shows a typical signal from one of the detectors. The signal includes a background or baseline signal 31, particle peaks 32, noise spikes 33 and low amplitude particle peaks 34. In order to reject noise spikes and low amplitude particle signals, a threshold value must be set for each detector prior to conducting a particle analysis or assay. For this purpose, the sample is run for a predetermined time and the digitized data is collected in the buffer. The buffered data is processed by the processor or computer 41 configured to obtain a base value 31 for each detector. To do this, the particle signals are subtracted and the RMS value of the remaining signal provides the base value 42, FIG. 4B. Then, a gap 43 is added to establish the threshold 44, FIG. 4C, above which output signals represent peaks. During an analysis, noise spikes or low level particle signals, etc. are eliminated. The gap 43 can be set by the operator since the peak value is highly variable and can be very low. For very low peaks, the gap value 43 is set so that the threshold 44 is close to the background or base value 42.

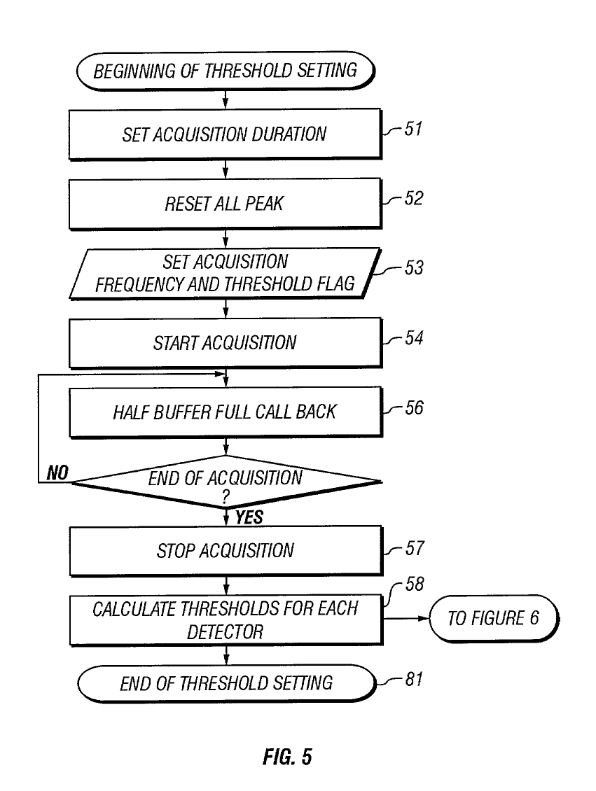

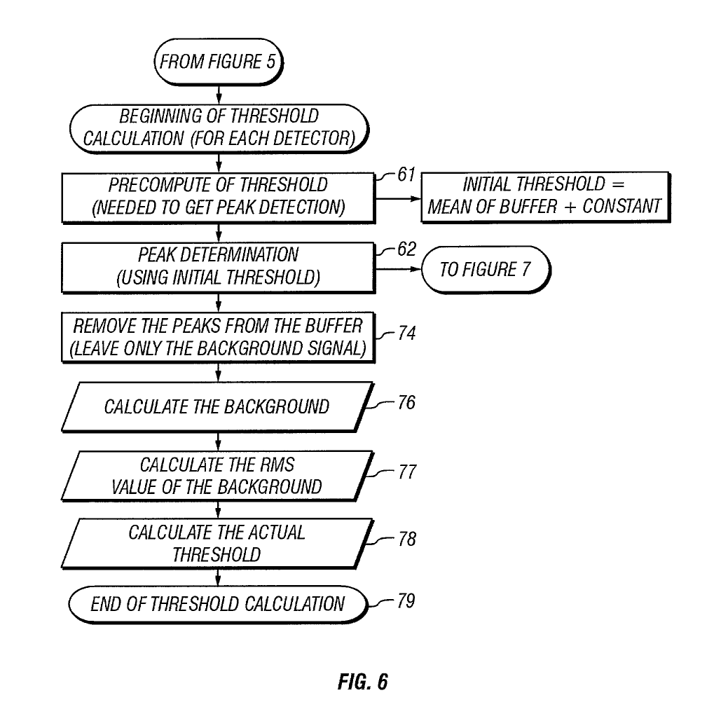

As explained above, the sample is processed for a predetermined short time and the digitized data stored in a buffer. The buffered data is then processed to obtain the base value. FIG. 5 is a flow diagram illustrating the steps involved in setting the threshold. The duration of data acquisition is set in step 51. All peak or object values in the buffer are reset, step 52. The acquisition frequency and threshold flag is set, step 53, and data acquisition is commenced, step 54. The buffer is filled, step 56, and acquisition is ended, step 57. Data processing to calculate the threshold value for each detector can commence, step 58, detailed in FIG. 6.

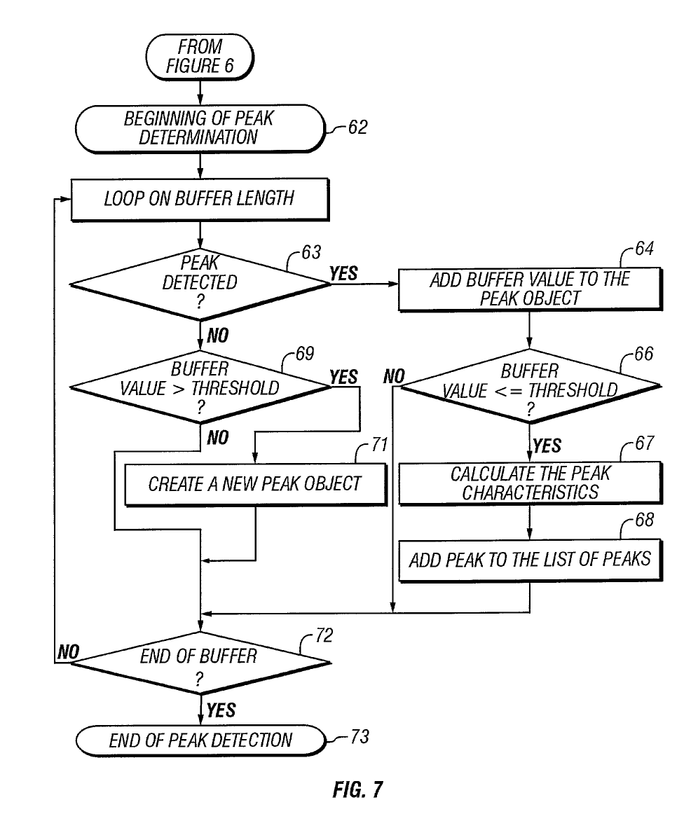

The first processing step in determining the threshold is to set a threshold, step 61, FIG. 6. This can, for example, be a calculation of the mean of the values stored in the buffer, plus a constant. The next step is to perform a peak determination 62, FIG. 7, using the preset threshold. The next step, 63, FIG. 7, in peak determination is to detect whether or not peaks are present. When the digital value is above the threshold value, a peak is in progress. The value is added to the buffer value, step 64. This continues until the buffer value is greater or equal to the threshold value, step 66, which signals the end of a peak. The peak characteristics are then computed, step 67, and the data is added to the list of peaks in a storage buffer. As long as the buffer value is greater than the threshold value, step 68, the processor is set to create a new peak, step 71. The process is repeated for each peak until the lapse of a predetermined time at which the processor indicates end of buffer, step 72, and peak determination is ended, step 73.

Returning now to FIG. 6, The peaks are removed from the buffered data, step 74, and the background value is calculated, step 76. The RMS value of the background is then calculated, step 77, and a gap value is added, step 78. The threshold calculation for each detector is then completed, step 79. The threshold value is then set, step 81, FIG. 5.

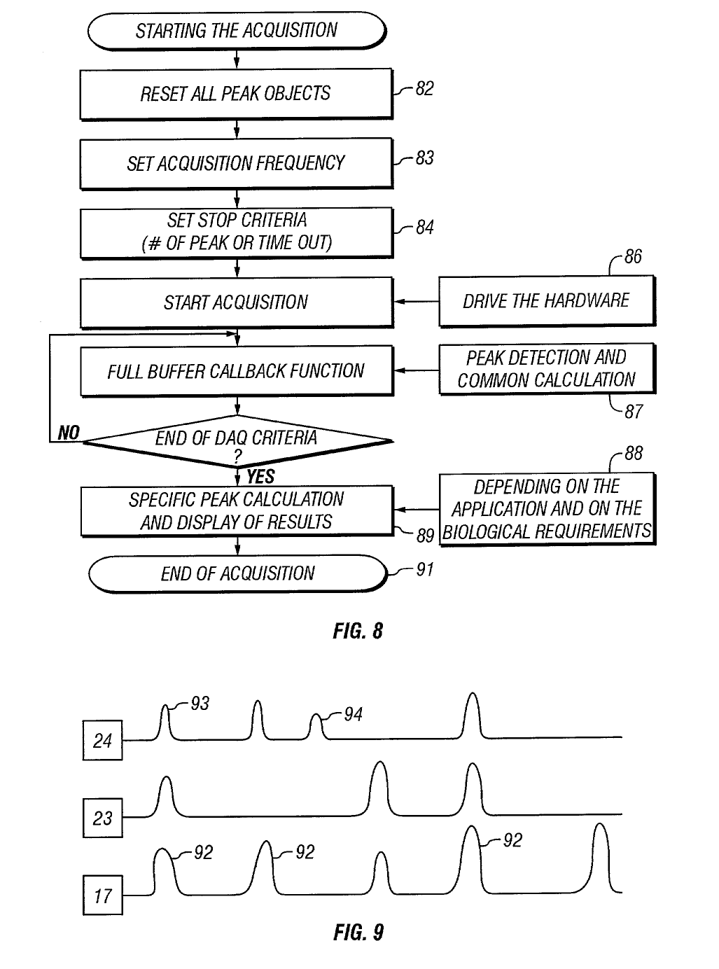

Now that the threshold is set for each detector a sample assay can be commenced. FIG. 8 shows the steps in data acquisition. The first step is to set all peaks in the buffers to zero, reset all objects, step 82. The acquisition or sampling frequency is then set 83. As explained above this is determined by the size of the particles and the flow rate of the sample. In step 84 the criteria for stopping an acquisition is set. This can be the number of peaks to be detected or a period of time depending upon the particular analysis being carried out. The sample is then caused to flow in the cytometer by driving the hardware 86. As the buffer is filled peak detection and calculations 87 are carried out in the manner described with respect to FIG. 7. Depending on the application and on the biological requirements 88 specific peak calculations can be performed 89, and the results displayed 91.

A matrix of typical calculated peak data from a cytometer using a scatter detector 17 and two fluorescence detectors 23 and 24 is shown in FIG. 9. The peak acquisition was controlled by the scatter detector so that only fluorescent peaks which occur at the same time as a scatter signal peaks 92 will be recognized. It is seen that the peaks 93 are time stamped and their height and width are shown. An extraneous peak is shown at 93.

Thus there has been described a process for determining the threshold value for each detector in a cytometer. Briefly, the outputs for a brief period of time from each detector is digitized and stored in a buffer. The peaks are removed from the signal and the buffer rebuilt. The mean and the RMS value is then calculated and a threshold value is calculated using a gap parameter. Peak detection both for threshold determination and sample analysis uses a simple algorithm based on sequential analysis of the acquisition buffer. Each sample is compared to the threshold value and the process depends on the current state of the analysis. The states are: no peak detected, new peak detected and end of peak. During these three states peak parameters are calculated and stored. When the count of peaks reaches the requested number of events or the acquisition time has elapsed acquisition is stopped and specific calculations, display and storage of the results for each application can be performed.

What is claimed is:

1. In a cytometer system of the type in which a stream containing sample particles flows past a light beam and particles, which fluoresce or are tagged to fluoresce responsive to said light, emit light and a detector receives said emitted light and generates an output signal which includes a base value representative of background and electronic noise and peaks representative of said particles as they pass through said light beam, and
a signal processing means including a processor for receiving said output signal and configured to generate a base value representative of said background and electronic noise and for setting a threshold value above said base value for thereafter generating signals responsive only to said emitted light.

2. A cytometer system as in claim 1 including a detector for detecting light scattered by said particles and generating an output signal which includes a base value representative of background and electronic noise and peaks representative of passage of particles through said light beam,
said processing means receiving said output signal and generating a base value representative of said background and electronic noise and for setting a threshold value above said base value for thereafter generating signals responsive only to scattered light.

3. A cytometer as in claim 1 or 2 in which said processing means samples and digitizes the output signals for application to said processor.

4. A cytometer as in claim 3 in which the processor determines the base value by processing only the background and electronic noise value of said output signal.

5. A cytometer system for analyzing particles in a sample stream comprising:
a light source for projecting a light beam,
means for causing the sample stream containing particles which fluoresce or are tagged to fluoresce and emit light when they traverse said light beam,
one or more detectors for detecting light emitted by said particles as they traverse the light beam and generate an output signal and a detector for detecting light scattered by particles as they traverse said light beam and generate an output signal, said output signals including background and electronic noise components,
digitizing means for receiving said output signals and providing representative digital signals for the output signals of each of said detectors,
a processor for receiving said digitized signals for each of said detectors and for generating a base value representative of said background and electronic noise components and adding a threshold value to said base value, and
wherein said system is thereafter configured to generate signal peaks when the emitted light detector output exceeds its threshold value and when the scattered light detector output exceeds its threshold value.

6. A cytometer system as in claim 5 in which the processor is configured to detect a predetermined number of particles.

7. A cytometer system as in claim 5 in which the processor is configured to detect particles over a predetermined period of time.
